(19) United States
(12) Patent Application Publication
(10) Pub. No.: US 2021/0277876 A1
(43) Pub. Date: Sep. 9, 2021

(54) PLANETARY GEARBOX, DRIVE TRAIN, WIND TURBINE AND INDUSTRIAL APPLICATION

(71) Applicant: Flender GmbH, 46395 Bocholt (DE)

(72) Inventors: DOMINIKUS DANERS, Herten (DE); ARNO KLEIN-HITPASS, Aachen (DE)

(73) Assignee: Flender GmbH, 46395 Bocholt (DE)

(21) Appl. No.: 17/255,892

(22) PCT Filed: Jun. 5, 2019
(86) PCT No.: PCT/EP2019/064566

§ 371 Date: Dec. 23, 2020

(30) Foreign Application Priority Data
Jun. 25, 2018 (EP) 18179589.9

(51) Int. Cl. F03D 15/00; F03D 9/25; F03D 80/70

(52) U.S. Cl. CPC F03D 15/00; F03D 9/25; F05B 2260/40311; F05B 2220/706; F05B 2240/54; F03D 80/70

(57) ABSTRACT

A planetary gearbox includes an input shaft configured to introduce a driving torque of at least 1500 kNm, and three consecutively connected gearing stages operably connected to the input shaft for supply of the driving torque unbranched through each of the gearing stages. A first one of the gear stages and a second one of the gear stages are configured as planetary stages, respectively. Each of the planetary stages includes a ring gear embodied as a stationary gearing component. A third one of the gear stages is embodied as a planetary stage having a stationary gearing component. The first one of the gearing stages includes at least five planetary gears.

The Invention relates to a planetary gearbox with a plurality of gearing stages and a drive train for a wind turbine, which is equipped with a corresponding planetary gearbox. The invention also relates to a wind turbine having a corresponding drive train. Furthermore, the invention relates to an industrial application equipped with a planetary gearbox according to the invention.

A planetary gearbox for a wind turbine having a first and a second gearing stage, wherein the second gearing stage is connected to a spur gear stage, is known from the previously unpublished European patent application with file number EP 17152660.1.

The published, unexamined DE 10 2011 106 534 A1 discloses a gearbox for a wind turbine comprising two planetary stages connected to a summator gear train. The summator gear train is connected to a generator via a spur gear stage.

Furthermore, a gearbox embodied to drive a scroll centrifuge is known from the document WO 2016/016645 A2. The gearbox has two input shafts connected to different planetary stages. A first planetary stage accommodates a stepped planetary gear. One of the input shafts is embodied to provide a basic drive power and the other input shaft to provide a regulating drive power.

WO 2009/016508 A2 discloses a gearbox to be used in a wind turbine having two consecutively connected planetary stages. The consecutively connected planetary stages are coupled to a further planetary stage via a spur gear stage. A sun shaft of the further planetary stage can be connected to an auxiliary motor or auxiliary generator via a coupling. The auxiliary motor or auxiliary generator can be used to adjust an output speed with which a main generator is driven.

Gearbox engineering has a requirement for gearboxes that are suitable for transporting higher shaft powers from an input shaft to an output shaft and herein for changing the speed and correspondingly the present torque to a desired extent. In particular, higher overall gear ratios for higher drive powers are sought. At the same time, there are requirements for corresponding gearboxes to be simple and economical to manufacture. Similarly, a compact design of such gearboxes is desired. These objectives are found to a particular extent in the field of wind turbine technology and in the case of gearboxes for industrial plants. The invention is based on the object of providing a gearbox that offers an improvement in at least one of these aspects.

The object is achieved by the planetary gearbox according to the invention. The planetary gearbox comprises at least three consecutively connected gearing stages that are engaged with one another. The consecutive connection routes a supplied drive power completely, i.e. unbranched, through each gearing stage. Herein, the first and second gearing stage are embodied as planetary stages, wherein each of the planetary stages comprises a ring gear, a planetary carrier with planetary gears accommodated such that they can rotate therein and a sun gear as gearbox components. The second gearing stage is arranged directly between the first and third gearing stage. According to the invention, the second gearing stage is coupled to the third gearing stage, which is embodied as a planetary stage with a stationary gearing component.

Alternatively, the third gearing stage can also be embodied as a spur gear stage. A third gearing stage of this kind embodied as a spur gear stage is in turn coupled to a fourth gearing stage, which is also embodied as a spur gear stage. Consequently, the outlined alternative for the planetary gearbox has a consecutive connection of two planetary stages and two spur gear stages. The invention is inter alia based on the finding that an increased overall gear ratio and increased torque density can be achieved by means of a consecutive connection of at least three planetary stages or two planetary stages and two spur gear stages. At the same time, corresponding planetary gearboxes are also surprisingly compact even when designed for increased drive powers. The increased overall gear ratio in turn permits the use of generators with a reduced number of pole pairs in wind turbines. The lower the so-called pole pair number, the simpler and more economical the generator is to manufacture. In particular, depending upon the embodiment of the invention, generators with only four pole pairs, preferably even generators with only two pole pairs, can be used with wind turbines while the dimensions remain the same. The planetary gearbox according to the invention permits the use of simpler generators for the wind turbine while the dimensions remain the same. Equally, the gearbox according to the invention offers an advantageous possibility for making existing wind turbines more economical over the course of retrofitting.

Further, according to the invention, in each case a ring gear of the first and second gearing stage is embodied as a stationary gearing component, i.e. the corresponding ring gear does not rotate about the main axis of rotation of the planetary gearbox during operation. Ring gears are typically the heaviest gearbox components and thus a stationary ring gear reduces the rotating masses, which in turn increases the smooth running of the planetary gearbox. With planetary stages of this kind, drive power and output power are only supplied and removed via the associated planetary carrier and the sun gear, respectively. Accordingly, it is easy to couple planetary stages of this kind to adjacent gearing stages. Overall, this enables the achievement of a simple, reliable and low-noise combination of a plurality of planetary stages or a planetary stage with a spur gear stage.

In one embodiment of the claimed planetary gearbox, in which the third gearing stage is embodied as a planetary stage, this is embodied to be directly coupled to a generator. Herein, the generator preferably has three or four pole pairs. A direct coupling should be understood as being a torque-transmitting connection with which the prevailing speed and the prevailing torque remain the same, i.e. there is no longer any gearbox effect. With a consecutive connection of three planetary stages achieved in this way, the input shaft and an output shaft of the planetary gearbox are substantially coaxial, which saves space in the radial direction. Furthermore, a corresponding planetary gearbox has an overall gear ratio of 20 to 200, preferably 40 to 120. Based on the usual rotor speeds of a wind turbine, such speeds permit the use of a generator with two to four pole pairs.

Alternatively, the third gearing stage can also be connected to a fourth gearing stage embodied as a spur gear stage. A corresponding planetary gearbox has three consecutively connected planetary stages and a spur gear stage connected therebehind. In such a planetary gearbox, the overall gear ratio is achieved by the combination of four gearing stages, which in each case have a reduced fixed carrier train ratio. The fixed carrier train ratios of the gearing stages being reduced means they are exposed to less mechanical stress while the drive power to be transported remains the same. This in turn permits the individual gearing stages, in particular the first and/or second gearing stage, to be embodied in a space-saving manner in the radial direction and thus provide a compact planetary gearbox. Furthermore, an increased overall gear ratio can be achieved while the dimensions remain the same. In detail, a corresponding planetary gearbox has an overall gear ratio of 50 to 350, preferably 100 to 220. The higher the overall gear ratio of the claimed planetary gearbox, the lower is the required pole pair number of the generator to be driven. The claimed planetary gearbox is preferably embodied on the fourth gearing stage to be directly coupled to a generator with two or three pole pairs.

According to one of the alternatives outlined, a fourth gearing stage embodied as a spur gear stage can be provided in the claimed planetary gearbox. Herein, the fourth gearing stage is connected to the third gearing stage, which is also embodied as a spur gear stage. In this alternative, the claimed planetary gearbox has a consecutive connection of two planetary stages and two spur gear stages. Moreover, the fourth gearing stage can be embodied to be directly coupled to a generator with two, three, four, eight or 16 pole pairs. The planetary gearbox offers an increased overall gear ratio that enables the use of a generator with a correspondingly low number of pole pairs. This enables the use of a simpler and more cost-efficient generator. The planetary gearbox furthermore saves space in the axial direction, i.e. along a main axis of rotation of the planetary gearbox. In addition, spur gear stages can be manufactured in a simple and cost-efficient manner. Overall, the economic efficiency of a drive train of a wind turbine equipped with a corresponding planetary gearbox is increased.

In the claimed planetary gearbox, the first gearing stage can have five to twelve, preferably seven to ten planetary gears. The higher the number of planetary gears in a planetary stage, the lower the fixed carrier train ratio that can be achieved with the planetary stage. At the same time, the mechanical stresses resulting from the drive power introduced are distributed over an increased number of planetary gears and contact points in the ring gear. A more uniform distribution of this kind offers a local reduction in the mechanical stresses, which is in turn associated with increased torque density, increased service life and increased reliability of the planetary stage. Hence, the use of three or four gearing stages makes it possible to achieve an overall increased overall gear ratio with reduced fixed carrier train ratios in the first and/or second gearing stage and at the same time to increase the reliability of the planetary stages, i.e. the first and/or second gearing stage. In particular in the case of embodiments consisting of three consecutively connected planetary stages, a first gearing stage with at least 7, particularly preferably with seven to ten planetary gears is advantageous. Such a first gearing stage is preferably coupled to a second gearing stage with five to twelve, preferably seven to ten planetary gears. Further preferably, the planetary gears can be embodied such that they have substantially the same dimensions and are particularly preferably mutually exchangeable. This enables the planetary gears for the first and second gearing stage to be produced from the same raw parts, thus simplifying the manufacture of the planetary gearbox. The use of mutually exchangeable planetary gears in the first and second gearing stage enables the same parts to be used which in turn permits manufacture to be simplified even further. This is inter alia based on the surprising finding that the choice of corresponding numbers of planetary gears in the individual gearing stages both increases the torque density and at the same time production is considerably simpler and more economical. With such an embodiment, the third gearing stage has at least three, preferably at least four or five planetary gears. With corresponding numbers of planetary gears in the individual gearing stages, the technical advantages of the claimed planetary gearbox are achieved to a particular extent. In particular, a corresponding planetary gearbox permits two-stage planetary gearboxes to be replaced in an at least technically equivalent manner in a cost-efficient way. Furthermore, a suitable choice of numbers of planetary gears enables the claimed planetary gearbox to be set to a large number of overall gear ratios which offers a wide range of possible uses.

In a further embodiment of the claimed planetary gearbox, an input shaft is embodied to introduce a torque of at least 1500 kNm. This approximately corresponds to a wind turbine with a nominal power of 1.5 MW. The input shaft is preferably embodied to introduce a torque of 1500 kNm to 20000 kNm. When used in an onshore wind turbine, the input shaft is preferably embodied to introduce a torque of 1500 kNm to 10000 kNm. When used in an offshore wind turbine, the input shaft is preferably embodied to introduce a torque of 5000 kNm to 20000 kNm. These value ranges substantially correspond to the nominal power ranges of corresponding wind turbines. In addition, the claimed planetary gearbox is also suitable to be equipped with an input shaft designed to introduce torques over 20000 kNm into the planetary gearbox. As a result, the claimed planetary gearbox is scalable and also suitable for future wind turbines that will offer even higher nominal powers. The claimed planetary gearbox is inter alia based on the finding that, even from drive powers with a torque of approx. 1500 kNm, at least one additional gearing stage offers not only an increased overall gear ratio but also a reduced or at least constant size, in particular in terms of the outer diameter, and at the same time is simple and economical to manufacture.

In a further embodiment of the claimed planetary gearbox, the first gearing stage can have a fixed carrier train ratio of 2.5 to 4.4. Additionally or alternatively, the second gearing stage can have a fixed carrier train ratio of 2.5 to 6. Preferably, the fixed carrier train ratios of the first and second gearing stage are substantially the same size so that the fixed carrier train ratios of the first and second gearing stage are correspondingly minimized. This reduces the largest outside diameter, the gear box length of the planetary gearbox and the weight thereof, which are decisive for the transportation of the planetary gearbox. As a result, the claimed planetary gearbox is easy to transport which in turn permits simplified assembly with increased economic efficiency in the manufacture of a wind turbine. Moreover, the tower head mass of a wind turbine with a corresponding planetary gearbox is reduced thus enabling further constructive savings on the wind turbine to be achieved, for example due to a lighter tower construction.

Furthermore, the planetary carrier of the second gearing stage can be connected in a rotationally rigid manner to a sun gear of the first gearing stage in the described planetary gearbox. Such a rotationally rigid connection can be established in a simple way via a stub toothing on a hub of the planetary carrier of the second gearing stage and on the sun gear of the first gearing stage. This permits an advantageous consecutive connection of the first and second gearing stage. Such a rotationally rigid connection between the first and second gearing stage can be established in a simple way and can also be installed in a rapid manner. Alternatively or supplementarily, this connection can also be embodied as rigid, for example, by a material fit or form fit.

In the claimed planetary gearbox, furthermore, the planetary carrier of the first and/or the third gearing stage can in each case be accommodated such that it can rotate in a bearing attached to a wall of the housing. As a result, the gearing stages embodied as planetary stages are only supported on one side on the housing. The position of the further gearbox components is set by the prevailing drive power during operation which is routed through the gearbox components. This achieves self-adjusting centering during operation. In particular, reducing the bearings used reduces the number of mechanical constraints. For example, radial bearings can be dispensed with in each case for the planetary carrier of the second and third gearing stage. Instead, the planetary carrier of the second and third gearing stage can be equipped only with guide bearings, preferably for reduced torque ranges. It is only necessary to use axial bearings for the planetary carrier of the second and third gearing stage if helical toothing is used. Herein, the bearings used, which are attached to the wall of the housing, can be embodied as roller bearings or plain bearings. The use of plain bearings reduces the effort required to provide lubricant, for example through lubricant channels, and this in turn simplifies the manufacture of the planetary gearbox. Moreover, for both roller bearings and plain bearings, the effort required to set the bearings is considerably reduced. Furthermore, the requirement for precisely produced bearing mounts, which further simplifies the production of the planetary gearbox and renders it more cost-efficient.

In a further embodiment of the claimed planetary gearbox, at least one of the gearing stages is embodied to couple regulating power into the planetary gearbox. The regulating power is used to compensate fluctuating drive power and to ensure the most constant possible operation of an attached generator or mechanical application. The regulating power is by a regulating apparatus can be embodied as an electric machine, in particular a motor generator. An electric machine permits rapid switching from motor operation to generator operation so that it is additionally possible to provide a driving or braking torque. For this purpose, each of the gearbox components of the gearing stage connected to the regulating apparatus can be embodied such that they can rotate. For example, a ring gear of the corresponding gearing stage can be connected to the regulating apparatus in a torque-transmitting manner. Furthermore, the gearing stage connected to the regulating apparatus can be a planetary stage. The third gearing stage is preferably embodied as a planetary stage and coupled to the regulating apparatus. In the third gearing stage, speeds are present that advantageously in a simple way permit precise regulation of the output power that is further transported to the generator or the mechanical application. Herein, regulation by means of the regulating apparatus should be understood as meaning influence with a closed regulation loop and/or an open regulation loop, i.e. a control system.

The described object is also achieved by a drive train according to the invention. The drive train is designed to be used in a wind turbine and comprises a rotor shaft that can be connected to a rotor of the wind turbine. The drive train also comprises a gearbox connected in a torque-transmitting manner to the rotor shaft. Furthermore, the drive train has a generator that is also connected in a torque-transmitting manner to the gearbox. According to the invention, the gearbox is embodied as a planetary gearbox according to one of the above-described embodiments. A corresponding drive train has improved performance compared to the solutions known from the prior art while the dimensions remain the same and is therefore embodied to transport higher drive powers from the rotor of the wind turbine to the generator. Alternatively, a drive train according to the invention has reduced dimensions, in particular a reduced outer diameter on the gearbox, compared to the known solutions while the drive power remains the same. Furthermore, the generator of the drive train has two to four pole pairs. Such a generator can be manufactured in a simple and cost-efficient manner. In this way, the economic efficiency of the drive train is increased overall.

The object outlined is also achieved by a wind turbine according to the invention. The wind turbine has a rotor attached to a nacelle. The rotor is connected in a torque-transmitting manner to the rotor shaft, which is in turn assigned to a drive train of the wind turbine. In this way, a rotation of the rotor is transmitted to the drive train via the rotor shaft. The claimed wind turbine is embodied with a drive train according to the above-described aspects of the invention, i.e. it has a gearbox embodied as a planetary gearbox according to one of the embodiments outlined. The technical advantages of the described drive train make the wind turbine according to the invention more powerful, more compact and more cost-efficient than known wind turbines.

The underlying object is also achieved by an industrial application according to the invention having drive means connected to a gearbox in a torque-transmitting manner. Herein, the drive means can, for example, be embodied as an electric motor, an internal combustion engine or a hydraulic motor. The gearbox is embodied, by converting speed and torque, to further transport a drive power provided by the drive means as an output power to a mechanical application. For this purpose, a torque-transmitting connection is established between the gearbox and the mechanical application. Herein, the mechanical application can be embodied as a mill, vertical mill, sugar mill, cement mill, rock crusher, conveyor belt, pump, roller press, apron conveyor, tube mill, rotary kiln, rotating mechanism, agitator, lifting apparatus, garbage press or scrap press. According to the invention, the gearbox is embodied in the industrial application as a planetary gearbox according to one of the outlined embodiments. Herein, the planetary gearbox can also be connected to the drive means and the mechanical application such that a reduction in the prevailing speed is achieved from the drive means to the mechanical application. In the industrial application according to the application, the prevailing torque density is increased thus, for example, permitting a compact design. The technical advantages of the claimed planetary gearbox are transferred in a corresponding way to an industrial application. Herein, the mechanical application technically substantially corresponds to the generator if the planetary gearbox is used in an industrial application instead of in a wind turbine. Herein, the rotor of the wind turbine corresponds to the drive means.

The invention is described below with reference to individual embodiments. Herein, the features of the individual embodiments can be combined with one another. The figures should be read as mutually complementary insofar that the same reference characters in the figures also have the same technical meaning. In the individual figures:

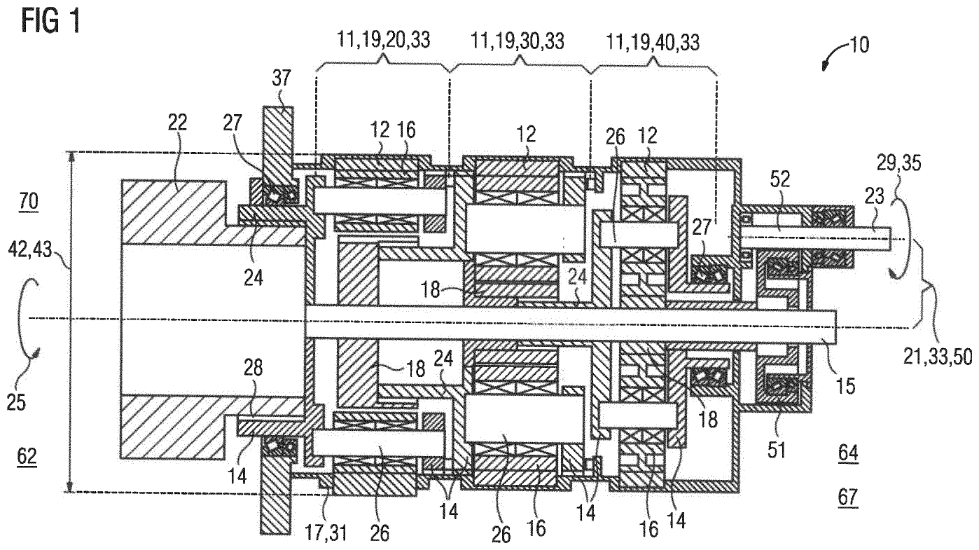

FIG. 1 shows a schematic depiction of a first embodiment of the claimed planetary gearbox;

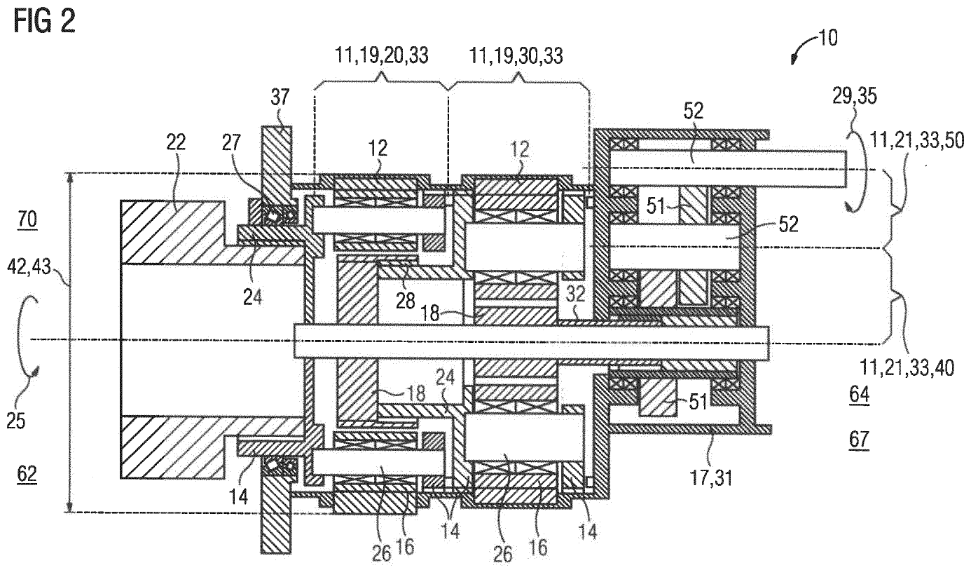

FIG. 2 shows a schematic depiction of a second embodiment of the claimed planetary gearbox;

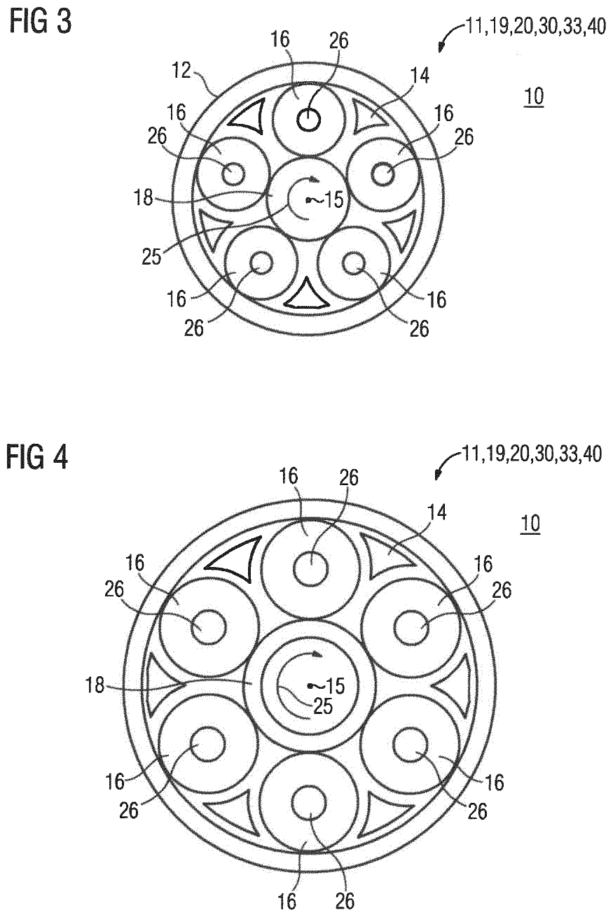

FIG. 3 shows a schematic depiction of a first embodiment of a gearing stage of a claimed planetary gearbox in cross section;

FIG. 4 shows a schematic depiction of a second embodiment of a gearing stage of a claimed planetary gearbox in cross section;

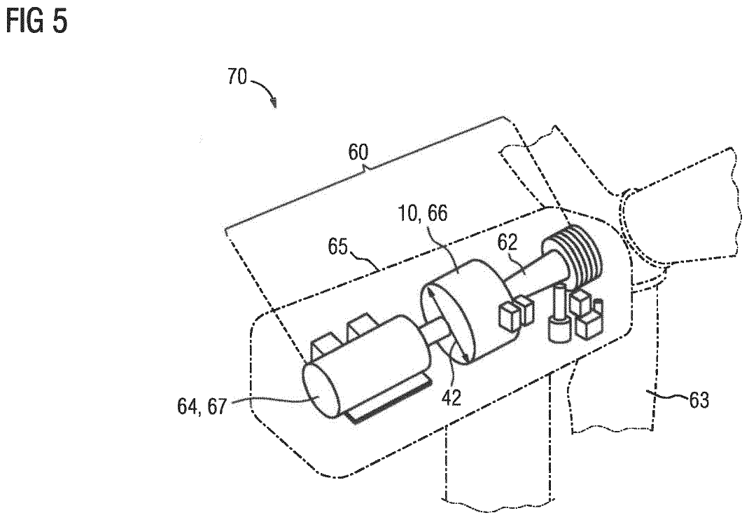

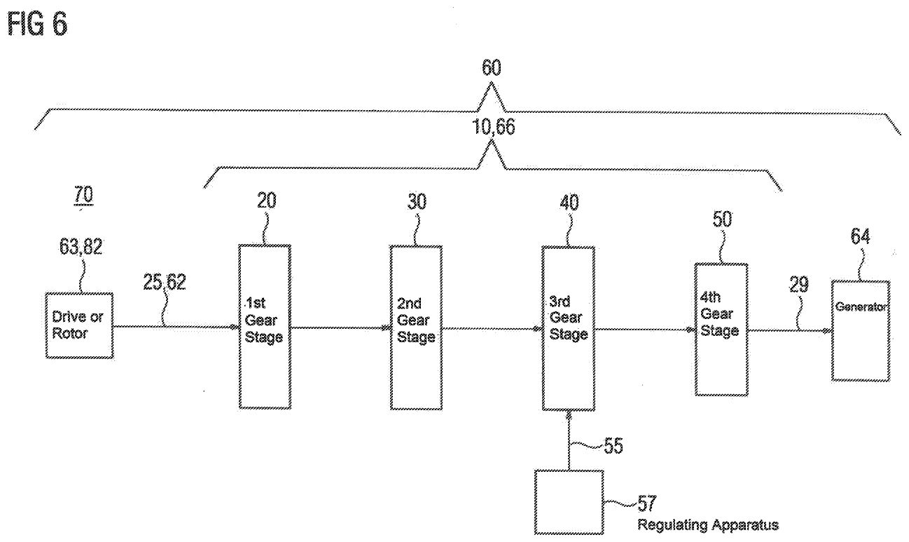

FIG. 5 shows a sectional oblique view of an embodiment of the claimed wind turbine with the claimed drive train;

FIG. 6 shows a schematic depiction of an embodiment of the claimed drive train;

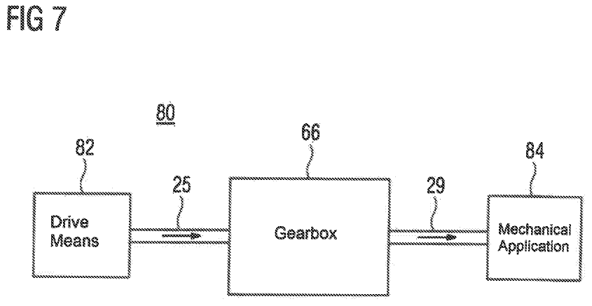

FIG. 7 shows a schematic depiction of a claimed industrial application.

FIG. 1 shows a schematic view of the structure of a first embodiment of the claimed planetary gearbox 10 embodied inter alia to be used in a wind turbine 70, not depicted in any further detail. The planetary gearbox 10 has a first, a second and a third gearing stage 20, 30, 40 embodied as planetary stages 19. The gearing stages 20, 30, 40 embodied as planetary stages 19 in each case have a plurality of gearbox components 11. For each planetary stage 19, the gearbox components 11 include inter alia a ring gear 12, a planetary carrier 14 to which a plurality of planetary gears 16 are rotatably attached and a sun gear 18. The planetary gearbox 10 has an input shaft 22 which, when the planetary gearbox 10 is used in a wind turbine 70 can be connected to a rotor shaft 62, not depicted in further detail, or is embodied in one piece with the rotor shaft 62. Drive power 25 can be introduced into the planetary gearbox 10 via the input shaft 22. The input shaft 22 is provided with stub toothing 28 that engages with corresponding stub toothing 28 on a so-called long hub 24 of the planetary carrier 14 of the first gearing stage 20. In the region of the stub toothing 28, the planetary carrier 14 of the first gearing stage 20 is accommodated such that it can rotate in a bearing 27 attached to a wall 31 of a housing 17. Herein, the bearing 27 is embodied as a two-row roller bearing. The drive power 25 is introduced into the planetary gearbox 10 via the stub toothing 28 and the planetary carrier 14 of the first gearing stage 20. The ring gear 12 of the first gearing stage 20 is connected in a rotationally rigid manner to the housing 17 so that the ring gear 12 does not rotate about a main axis of rotation 15 of the planetary gearbox 10 during operation. Planetary gears 16 that are in each case accommodated such that they can rotate on a planetary gear axis 26 engage with the ring gear 12 of the first gearing stage 20. The first gearing stage 20 has a fixed carrier train ratio 33 of substantially 2.5 to 4.4.

The planetary gears 16 of the first gearing stage 20 are in turn engaged with a sun gear 18 provided with stub toothing 28. The sun gear 16 of the first gearing stage 20 is also connected to the long hub 24 of the planetary carrier 14 of the second gearing stage 20. The second gearing stage substantially has the same structure as the first planetary stage. The first gearing stage 20 has at least five, preferably six or seven planetary gears 16, which influence the fixed carrier train ratio 33 of the first gearing stage 20. The second gearing stage 30 has at least four, preferably six or seven planetary gears 16. As with the first gearing stage 20, the number of planetary gears 16 also defines the fixed carrier train ratio 33 of the second gearing stage 30. The second gearing stage 30 has a fixed carrier train ratio 33 of substantially 2.5 to 6.0. Similarly to the first and second planetary stage 20, 30, the third gearing stage 40 is connected behind the second gearing stage 30. Hence, the drive power 25 introduced via the input shaft 22 into the planetary gearbox 10 is further transported during operation from the first gearing stage 20 to the second gearing stage 30 and from there to the third gearing stage 40. The third gearing stage 40 is also embodied as a planetary stage 19 and has a planetary carrier 14 accommodated such that it can rotate in a bearing 27. The bearing 27 is embodied as a two-row roller bearing and is fastened to a wall 31 of the housing 17. Furthermore, the third gearing stage 50 has at least three planetary gears 16, preferably four or five planetary gears 16. The three gearing stages 20, 30, 40 are mounted on the side of the input shaft 22 and an output shaft 23 in only two bearings on the housing 17. This reduces the mechanical constraints acting on the gearbox components 11 during operation. During operation, a state of equilibrium is established between the gearbox components 11, primarily by the introduced drive power 25, and the forces resulting therefrom. This reduces the noise generated during operation.

The sun gear 18 of the third gearing stage 40 is furthermore connected to a fourth gearing stage 50 embodied as a spur gear stage 21. The spur gear stage 21 comprises a spur gear 51 and a corresponding pinion 52 and has a fixed carrier train ratio 33. The spur gear stage 21 furthermore has an output shaft 23 from which an output power 29 can be discharged from the planetary gearbox 10. Taking into account mechanical losses, the output power 29 substantially corresponds to the drive power 25. The speed of the output power 29 is increased compared to the speed of the drive power 25 corresponding to an overall gear ratio 35, which is in turn determined by the fixed carrier train ratios 33 of the four gearing stages 20, 30, 40, 50. The overall gear ratio 35 of the planetary gearbox 10 achieved is embodied such that the output shaft 23 can be coupled directly to a generator 64, not depicted in further detail, which only has two or three pole pairs 67, not depicted in further detail in FIG. 1. Due to the corresponding number of planetary gears 16 in the planetary stages 19 of the first, second and third gearing stage 20, 30, 40, the first, second and third gearing stage 20, 30, 40 have substantially the same outer diameter 42. As a result, the greatest outer diameter 43 decisive for the transportation of the planetary gearbox 10 is minimized. The dimensions of torque arms 37 fastened to the housing 17 are not taken into account in this consideration.

FIG. 2 is a schematic depiction of the structure of a second embodiment of the claimed planetary gearbox 10 designed to be used in a wind turbine 70, not depicted in further detail. The planetary gearbox 10 has a first and a second gearing stage 20, 30, which are in each case embodied as planetary stages 19. Each of the planetary stages 19 has a plurality of gearbox components 11 including inter alia in each case a ring gear 12, a planetary carrier 14 and a sun gear 18. In the planetary carrier 14 in each of the two planetary stages 19, a plurality of planetary gears 16 is in each case accommodated such that they can rotate on a planetary gear axis 26 and engage with the associated ring gear 12 and the associated sun gear 18. Furthermore, the planetary gearbox 10 has an input shaft 22 that can be connected to a rotor shaft 62, not depicted in further detail, embodied in one piece therewith. The input shaft 22 is provided with stub toothing 28 that engages with corresponding stub toothing 28 on a so-called long hub 24. Drive power 25 is introduced into the first gearing stage 20, namely into the associated planetary carrier 14 via the input shaft 22 and forwarded to the second gearing stage 30. The planetary carrier 14 of the first gearing stage 20 is accommodated such that it can rotate in a bearing 27 attached to a wall 31 of the housing 17. Herein, the bearing 27 is embodied as a two-row roller bearing. A sun gear 18 of the first gearing stage 20 is provided with a stub toothing 28 with which a long hub 24 of the planetary carrier 14 of the second gearing stage 30 engages. For this purpose, the planetary carrier 14 on the long hub 24 is equipped with corresponding stub toothing 28. The second gearing stage 30 substantially has the same structure as the first gearing stage 20. In addition, the sun gear 18 of the second gearing stage 30 is coupled to the third gearing stage 40 via a sun shaft 32. The third gearing stage 40 is embodied as a spur gear stage 21 and has as a gearbox component 11 a spur gear 51, which meshes with a pinion 52. The pinion 52 of the third gearing stage 40 also belongs to the fourth gearing stage 50, which is also embodied as a spur gear stage 21. Furthermore, the fourth gearing stage 50 has a spur gear 51, which engages with a pinion 52, which is in turn connected to an output shaft 23 of the planetary gearbox 10. The third and fourth gearing stage 40, 50 in each case have a fixed carrier train ratio 33 by means of which the speed of the sun gear 18 of the second gearing stage 30 is further increased. A generator 64, not depicted in further detail, which advantageously only has two pole pairs 67, not depicted in further detail in FIG. 2, can be attached to the output shaft 23 of the gearbox. Output power 29 substantially corresponding to the drive power 25, taking mechanical losses into account is output to the generator 64 via the output shaft 23. Compared to the drive power 25, the prevailing speed of the output power 29 is increased according to an overall gear ratio 35. The overall gear ratio 35 is determined by the concatenation, i.e. the consecutive connection of the four gearing stages 20, 30, 40, 50.

Furthermore, FIG. 3 depicts a cross section of a first embodiment of a gearing stage 20, 30, 40 embodied as a planetary stage 19. The planetary stage 19 comprises as a gearbox component 11 a ring gear 12 which meshes with five planetary gears 16. For this purpose, each of the planetary gears 16 is accommodated such that it can rotate on a planetary gear axis 26. Each of the planetary gear axes 26 is connected to a planetary carrier 14. During operation, the planetary gears 16 rotate about a main axis of rotation 15 of a planetary gearbox 10, not depicted in further detail. The planetary gears 16 in turn mesh with a sun gear 18 via which a drive power 25 can be further transported in a torque-transmitting manner to an adjacent gearing stage 20, 30, 40. The planetary stage 19 in FIG. 3 can be used as a first, second or third gearing stage 20, 30, 40 in a planetary gearbox 10 and offers a fixed carrier train ratio 33.

Corresponding with FIG. 4, FIG. 3 shows a cross section of a second embodiment of a planetary stage 19 that can be used as a first, second or third gearing stage 20, 30, 40. In FIG. 3 and FIG. 4, the same reference characteristics have the same technical meaning. In contrast to FIG. 3, the planetary stage 19 in FIG. 4 has seven planetary gears 16. The planetary gears 16 in FIG. 3 and FIG. 4 have substantially the same sizes and can be manufactured from the same blank. This considerably simplifies the manufacture of the associated planetary gearbox 10. In addition, mechanical stresses in the planetary gears 16 are distributed over a corresponding number of contact points on the ring gear 12. The higher the number of planetary gears 16, the more uniform the distribution of mechanical stress.

FIG. 5 depicts a sectional oblique view of an embodiment of a wind turbine 70 according to the invention. The wind turbine 70 comprises a rotor 63 that can be set into rotation by wind. The rotor 63 is connected in a torque-transmitting manner via a rotor shaft 62 to a gearbox 66. The gearbox 66 is in turn connected in a torque-transmitting manner to a generator 64. The rotor shaft 62, the gearbox 66 and the generator 64 belong to a drive set 60 accommodated in a nacelle 65 of the wind turbine 70. The generator 64 has two, three or four pole pairs. The gearbox 66 is embodied according to one of the above-described embodiments. A correspondingly embodied gearbox 66 increases the efficiency of the wind turbine 70. In particular, a claimed planetary gearbox 10 offers a reduced diameter 42, which facilitates the installation of the wind turbine 70.

FIG. 6 shows a schematic structure of a further embodiment of the claimed drive train 60 that can be used in a wind turbine 70, not depicted in further detail, or an industrial application 80, not depicted in further detail. The drive train 60 comprises a gearbox 66 connected on the input side to a drive means 82 or a rotor 63 of the wind turbine 70 and to which in this way a drive power 25 is supplied. In a wind turbine 70, this takes place by means of a rotor shaft 62. The gearbox 66 is embodied as a planetary gearbox 10 and comprises a first, second, third and fourth gearing stage 20, 30, 40, 50 in each case comprising a plurality of gearbox components 11. The first, second and third gearing stage 20, 30, 40 are in each case embodied as planetary stages 19. The fourth gearing stage 50 is embodied as a spur gear stage 21. The gearing stages 20, 30, 40, 50 are consecutively connected and output an output power 29 to a generator 64 or a mechanical application 84. The third gearing stage 40 has as a gearing component 11 a ring gear 12 embodied such that it can rotate. Overall, the third gearing stage 40 does not have a stationary gearing component 11. The third gearing stage 40 is coupled to a regulating apparatus 57 embodied to couple a regulating power 55 into the third gearing stage 40. For this purpose, the regulating apparatus 57 is connected in a torque-transmitting manner to the ring gear 12 of the third gearing stage 40. The regulating apparatus 57 is embodied as an electric machine and is suitable to provide either a driving or a braking torque as a regulating power 55. Thus, fluctuations in the drive power 25 provided by the drive means 82 or the rotor 63 can be at least temporarily compensated. Alternatively or supplementarily, this enables a desired operating point to be set for the generator 64 or the mechanical application 84. The regulating apparatus 57 is embodied to implement a closed regulation loop or open regulation loop, i.e. a control system, or also a combination of the two.

FIG. 7 is a schematic depiction of the structure of an embodiment of an industrial application 80 with a drive means 82. The drive means 82 is embodied to provide a drive power 25 transported by a torque-transmitting connection to a gearbox 66. The gearbox 66 is in turn connected in a torque-transmitting manner to a mechanical application 84 in order to transport an output power 29 to the mechanical application 84. For this purpose, the gearbox 66 is embodied as a planetary gearbox 10 according to one of the embodiments outlined above.

1.-14. (canceled)

15. A planetary gearbox, comprising:
an input shaft configured to introduce a driving torque of at least 1500 kNm, and
three consecutively connected gearing stages operably connected to the input shaft for supply of the driving torque unbranched through each of the gearing stages, with a first one of the gear stages and a second one of the gear stages being configured as planetary stages, respectively, each of the planetary stages including a ring gear embodied as a stationary gearing component, and with a third one of the gear stages being embodied as a planetary stage having a stationary gearing component, said first one of the gearing stages including at least five planetary gears.

16. The planetary gearbox of claim 15, wherein the third one of the gearing stages is configured for direct coupling to a generator.

17. The planetary gearbox of claim 15, further comprising a fourth gearing stage embodied as a spur gear stage, said third one of the gearing stages being connected to the fourth gearing stage.

18. The planetary gearbox of claim 17, wherein the fourth gearing stage is configured for direct coupling to a generator with three, four, eight or 16 pole pairs.

19. The planetary gearbox of claim 15, wherein the second one of the gearing stages includes at least four planetary gears.

20. The planetary gearbox of claim 15, wherein the third one of the gearing stages includes at least three planetary gears.

21. The planetary gearbox of claim 15, wherein the first one of the gearing stages has a fixed carrier train ratio of 2.5 to 4.4 and/or the second one of the gearing stages has a fixed carrier train ratio of 2.5 to 6.

22. The planetary gearbox of claim 15, wherein the second one of the gearing stages includes a planetary carrier which is connected in a rotationally fixed manner to a sun gear of the first one of the gearing stages.

23. The planetary gearbox of claim 15, further comprising:
a housing, and
a bearing attached to a wall of the housing and configured to accommodate a planetary carrier of the first one of the gear stages for rotation, and/or
a bearing attached to a wall of the housing and configured to accommodate a planetary carrier of the third one of the gear stages for rotation.

24. The planetary gearbox of claim 17, wherein at least one of the first, second, third and fourth gearing stages is embodied to couple-in a regulating power.

25. A drive train, comprising:
a generator;
a gearbox connected in a torque-transmitting manner to the generator, said gearbox being configured as a planetary gearbox which comprises an input shaft configured to introduce a driving torque of at least 1500 kNm, and three consecutively connected gearing stages operably connected to the input shaft for supply of the driving torque unbranched through each of the gearing stages, with a first one of the gear stages and a second one of the gear stages being configured as planetary stages, respectively, each of the planetary stages including a ring gear embodied as a stationary gearing component, and with a third one of the gear stages being embodied as a planetary stage having a stationary gearing component, said first one of the gearing stages including at least five planetary gears; and
a rotor shaft connected in a torque-transmitting manner to the input shaft of the gearbox.

26. A wind turbine, comprising:
a nacelle;
a rotor attached to the nacelle; and
a drive train connected in a torque-transmitting manner to the rotor and arranged in the nacelle, said drive train comprising a generator, a gearbox connected in a torque-transmitting manner to the generator, said gearbox being configured as a planetary gearbox which comprises an input shaft configured to introduce a driving torque of at least 1500 kNm, and three consecutively connected gearing stages operably connected to the input shaft for supply of the driving torque unbranched through each of the gearing stages, with a first one of the gear stages and a second one of the gear stages being configured as planetary stages, respectively, each of the planetary stages including a ring gear embodied as a stationary gearing component, and with a third one of the gear stages being embodied as a planetary stage having a stationary gearing component, said first one of the gearing stages including at least five planetary gears, and a rotor shaft connected in a torque-transmitting manner to the input shaft of the gearbox.

27. An industrial application, comprising:
a gearbox coupled in a torque-transmitting manner to a mechanical application; and
a drive unit connected in a torque-transmitting manner to the gearbox,
wherein the gearbox is embodied as a planetary gearbox as set forth in claim 15.
